(19) United States
(12) Patent Application Publication
(10) Pub. No.: US 2010/0141687 A1
(43) Pub. Date: Jun. 10, 2010

(54) METHOD OF ARRANGING GAMMA BUFFERS AND FLAT PANEL DISPLAY APPLYING THE METHOD

(75) Inventors: Dae-Keun Han, Daejeon-si (KR); Dae-Seong Kim, Daejeon-si (KR); Joon-Ho Na, Daejeon-si (KR); Hong-Hee Son, Daejeon-si (KR); Hyun-Ho Cho, lncheon-si (KR); Hyung-Seog Oh, Cheongju-si (KR)

Correspondence Address: Jae Y. Park, Kile, Goekjian, Reed & McManus, PLLC, 1200 New Hampshire Ave. NW, Suite 570, Washington, DC, 20036, US

(73) Assignee: SILICON WORKS CO., LTD, Daejeon-si (KR)

(21) Appl. No.: 12/594,794

(22) PCT Filed: Mar. 26, 2008
(86) PCT No.: PCT/KR2008/001672

§ 371 Date: Oct. 5, 2009

(30) Foreign Application Priority Data
Apr. 16, 2007 (KR) 10-2007-003672I

(51) Int. Cl. G09G 5/10

(52) U.S. Cl. 345/690

(57) ABSTRACT

Provided are a method of arranging gamma buffers capable of decreasing a Kelvin of a source driver included in a flat panel display and minimizing a temperature deviation between source drivers, and the flat panel display applying the method. The method of arranging a plurality of gamma buffers which are arranged in one or more source drivers to output corresponding gamma voltages, includes a step of calculating power consumptions of the gamma buffers, wherein the method further comprises one or more steps of: changing tab points of the gamma buffers by using the calculated power consumptions of the gamma buffers; and changing positions of the gamma buffers by using the calculated power consumptions of the gamma buffers.

### BACKGROUND OF THE INVENTION

1. Field of the Invention

The present invention relates to a source driver integrated circuit (SDIC) of a flat panel display, and more particularly, to a method of arranging gamma buffers in source drivers.

2. Description of the Related Art

A camera converts an image signal into an electrical signal, and a display restores the electrical signal converted by the camera to the original image signal. Since the camera and the display have different photoelectric conversion properties from each other and the properties are not linear, correcting a different between the two is needed. In addition, a human eye has response characteristics having a log curve shape with respect to light incident into the human eye in order to receive brightness of light in a wide range. On the contrary, an image sensor included in the camera receives light having brightness in a limited dynamic range. Therefore, a complementary metal oxide semiconductor (CMOS) image sensor increases a gain in order to clearly represent a dark potion. In this case, a saturation phenomenon may occur in some bright portions.

Gamma correction has a function of changing brightness or luminance and is used to correct the nonlinearity of the photoelectric conversion characteristics of the image apparatus and the saturation phenomenon as described above. A mathematical expression applied to the gamma correction may be represented by a curve, and the curve is called a gamma curve. When a gamma value is set to a high value, a center portion of the curve is lifted, so that the screen becomes brighter. When the gamma value is set to a low value, the center portion of the curve is lowered, so that the screen becomes darker.

A flat panel display is an image display apparatus which is thinner and lighter than a television or a monitor using an existing cathode-ray tube (CRT) and has an enlarged screen. Examples of the flat panel display include liquid crystal displays (LCDs), plasma display panels (PDPs), and apparatuses using organic light emitting devices (OLEDs).

In general, the flat panel display includes six to eight source driver integrated circuits (SDICs). Each SDIC includes two gamma buffers for buffering predetermined gamma voltages. The gamma buffers are arranged in predetermined order according to voltages input to the gamma buffers and gray levels. The voltages output from the gamma buffers, for example, voltages dropped by respective 255 resistors that are connected in series, are transmitted to a resistor string having characteristics of the gamma curve.

In this case, due to the voltages to be buffered by the gamma buffers and resistances of the resistors that are connected to the gamma buffers and operate as a load, power consumptions of the gamma buffers are different from each other. Since the power consumptions of the gamma buffers are not equal, temperatures of the SDICs including the gamma buffers are different from each other.

FIG. 1 illustrates an arrangement of SDICs each of which includes two gamma buffers according to the gray levels.

FIG. 2 illustrates temperatures of the SDICs including the gamma buffers illustrated in FIG. 1.

FIG. 3 illustrates power consumptions of the SDICs including the gamma buffers illustrated in FIG. 1. Referring to FIG. 1, two source printed circuit boards (S-PCBs) 120 and 130 include SDICs 121,122, and 123 and 131, 132, and 133, respectively. The SDICs 121 to 133 include gamma buffers GB1-1 to GB6-2 so that each SDIC includes two gamma buffers. A center PCB (C-PCB) 110 controls operations of the two S-PCB 120 and 130.

Now, the power consumptions and the temperatures of the SDICs including the gamma buffers are described in detail with reference to FIGS. 1 to 3.

The first SDIC IC#1 121 includes the first and second gamma buffers GB1-1 and GB1-2 for buffering voltages VH255 and VL255, respectively. Referring to FIG. 2, a temperature of the first SDIC 121 is 50.5° C., and referring to FIG. 3, powers consumed by the first and second gamma buffers GB1-1 and GB1-2 are 11.9 mW and 3.5 mW, respectively. Therefore, a total power consumed by the two gamma buffers GB1-1 and GB1-2 is 15.4 mW. Here, the term VL is used to represent voltages from a lowest voltage to an intermediate voltage of a gamma voltage, and the term VH is used to represent voltages from the intermediate voltage to a highest voltage of the gamma voltage. For example, when it is assumed that the gamma voltage is 12V, the VL represents voltages from 0V to 5.9V, and the VH represents voltages from 6.1V to 12V. For example, VL255 represents 0V, and VL00 represents 5.9V. Similarly, VH00 represents 6.1V, and VH 255 represents 12V.

The second SDIC IC#2 122 includes third and fourth gamma buffers GB2-1 and GB2-2 for buffering voltages VH254 and VL254, respectively. A temperature of the second SDIC 122 is 61.0° C., and powers consumed by the third and fourth gamma buffers GB2-1 and GB2-2 are 87.2 mW and 82.7 mW, respectively. Therefore, a total power consumed by the two gamma buffers GB2-1 and GB2-2 is 169.8 mW.

The third SDIC IC#3 123 includes fifth and sixth gamma buffers GB3-1 and GB3-2 for buffering voltages VH191 and VL191, respectively. A temperature of the third SDIC 123 is 51.0° C., and powers consumed by the fifth and sixth gamma buffers GB3-1 and GB3-2 are 14 mW and 10.9 mW, respectively. Therefore, a total power consumed by the two gamma buffers GB3-1 and GB3-2 is 24.9 mW.

The fourth SDIC IC#4 131 includes seventh and eighth gamma buffers GB4-1 and GB4-2 for buffering voltages VH127 and VL127, respectively. A temperature of the fourth SDIC 131 is 52.0° C., and powers consumed by the seventh and eighth gamma buffers GB4-1 and GB4-2 are 11.7 mW and 10.5 mW, respectively. Therefore, a total power consumed by the seventh and eighth gamma buffers GB4-1 and GB4-2 is 22.1 mW.

The fifth SDIC IC#5 132 includes ninth and tenth gamma buffers GB5-1 and GB5-2 for buffering voltages VH31 and VL31, respectively. A temperature of the fifth SDIC 132 is 53.0° C., and powers consumed by the ninth and tenth gamma buffers GB5-1 and GB5-2 are 15.7 mW and 14.4 mW, respectively. Therefore, a total power consumed by the two gamma buffers GB5-1 and GB5-2 is 30.1 mW.

The sixth SDIC IC#6 133 includes eleventh and twelfth gamma buffers GB6-1 and GB6-2 for buffering voltages VH00 and VL00, respectively. A temperature of the sixth SDIC 133 is 55.6° C., and powers consumed by the eleventh and twelfth gamma buffers GB6-1 and GB6-2 are 43.5 mW and 42.7 mW, respectively. Therefore, a total power consumed by the two gamma buffers GB6-1 and GB6-2 is 86.2 mW.

FIG. 4 is a view for explaining operations of calculating the power consumptions of the gamma buffers illustrated in FIG. 1.

FIG. 4 illustrates circuits of output terminals of the gamma buffers on the left. Each of the output terminals includes a P-type metal-oxide-semiconductor (MOS transistor) and an N-type MOS transistor which apply different voltages to a gate terminal.

In a case where the first gamma buffer GB1-1 of the first SDIC IC#1 buffers a voltage VH255 of 16.61V, a turn-on resistance of the P-type MOS transistor is 0.05KΩ, a current flowing from a first source voltage Vdd to a load is 8.50 mA, a turn-on resistance of the N-type MOS transistor is 33.0KΩ, and a current flowing from the load to a second source voltage GND is 0.5 mA. Here, the load is not shown, however, generally has resistant components.

A power consumption P of a transistor is calculated by Equation 1 as follows.

P=R×I² [Equation 1]

Here, R denotes a turn-on resistance of the transistor, and I denotes a current flowing through the transistor.

Using Equation 1, a power consumed by the first gamma buffer GB1-1 of the first SDIC IC#1 is calculated as 11.9 mW. The power is obtained by adding a power of 3.6 mW consumed by the P-type MOS transistor and a power of 8.3 mW consumed by the N-type MOS transistor. In addition, a power consumed by the second gamma buffer GB1-2 of the first SDIC IC#1 is calculated as 3.5 mW (=0.1 mW+3.4 mW). Therefore, the total power consumed by the two gamma buffers GB1-1 and GB1-2 included in the first SDIC IC#1 is 15.4 mW.

Through the aforementioned calculations, the total power consumed by the first and second gamma buffers GB2-1 and GB2-2 of the second SDIC IC#2 is 169.8 mW (=87.2 mW+82.7 mW). Referring to FIG. 4, powers consumed by the two gamma buffers included in the third to sixth SDICs⁻IC#3 to IC#6 are 24.9 mW, 22.1 mW, 30.1 mW, and 86.2 mW, respectively.

As illustrated in FIG. 4, due to a difference between powers consumed by the gamma buffers included in each chip, as illustrated by a dotted rectangular in FIG. 2, the temperatures of the second and sixth SDICs IC#2 and IC#6 are significantly higher than remaining four chips.

A life span and reliability of a flat panel display are determined by a life span and reliability of each source driver. Particularly, in a case where a temperature of a specific IC of six or eight SDICs is higher than remaining SDICs, the life span and reliability of the specific IC is relatively lower than the remaining SDICs. In the flat panel display, when a defect occurs even in a single IC among a plurality of ICs, the flat panel display does not operate. Therefore, a decrease in a life span or reliability of a specific IC than other ICs has to be avoided.

### SUMMARY OF THE INVENTION

The present invention provides a method of arranging gamma buffers capable of decreasing a Kelvin of a source driver included in a flat panel display and minimizing a temperature deviation between source drivers.

The present invention provides a flat panel display capable of decreasing a Kelvin of a source driver included in the flat panel display and minimizing a temperature deviation between source drivers.

According to an aspect of the present invention, there is provided a method of arranging a plurality of gamma buffers which are arranged in one or more source drivers to output corresponding gamma voltages, including a step of calculating power consumptions of the gamma buffers, wherein the method further includes one or more steps of: changing tab points of the gamma buffers by using the calculated power consumptions of the gamma buffers; and changing positions of the gamma buffers by using the calculated power consumptions of the gamma buffers. In the above aspect of the present invention, in the step of changing the tab points of the gamma buffers, a voltage input to a gamma buffer consuming the highest power may be exchanged with a voltage input to a corresponding gamma buffer consuming the lowest power.

In addition, in the step of changing positions of the gamma buffers, a gamma buffer consuming the highest power and a gamma buffer consuming the lowest power may be disposed at the same source driver integrated circuit.

In addition, the step of changing the positions of the gamma buffers may further include a step of providing the gamma buffer consuming the highest power outside of the corresponding source driver integrated circuit. In addition, the gamma buffer provided outside the source driver integrated circuit may be provided to the same printed circuit board as the corresponding source driver integrated circuit.

According to another aspect of the present invention, there is provided a flat panel display comprising two or more gamma buffers and a plurality of source driver integrated circuits buffering a plurality of gamma voltages, wherein, by calculating power consumptions of the gamma buffers included in a plurality of the source driver integrated circuits, among the gamma buffers, a position of a gamma buffer consuming the highest power and a position of a gamma buffer consuming the lowest power are exchanged with each other to be included in the same source driver integrated circuit.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates an arrangement of source driver integrated circuits (SDICs) each of which includes two gamma buffers according to gray levels;

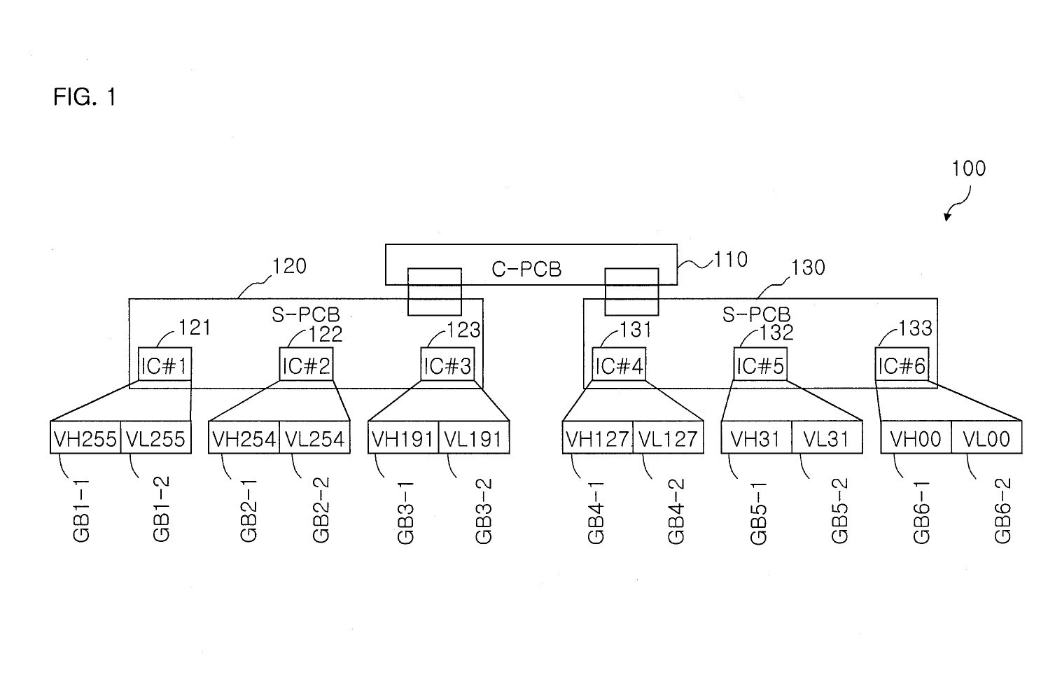

FIG. 2 illustrates temperatures of the SDICs including the gamma buffers illustrated in FIG. 1;

FIG. 3 illustrates power consumptions of the SDICs including the gamma buffers illustrated in FIG. 1;

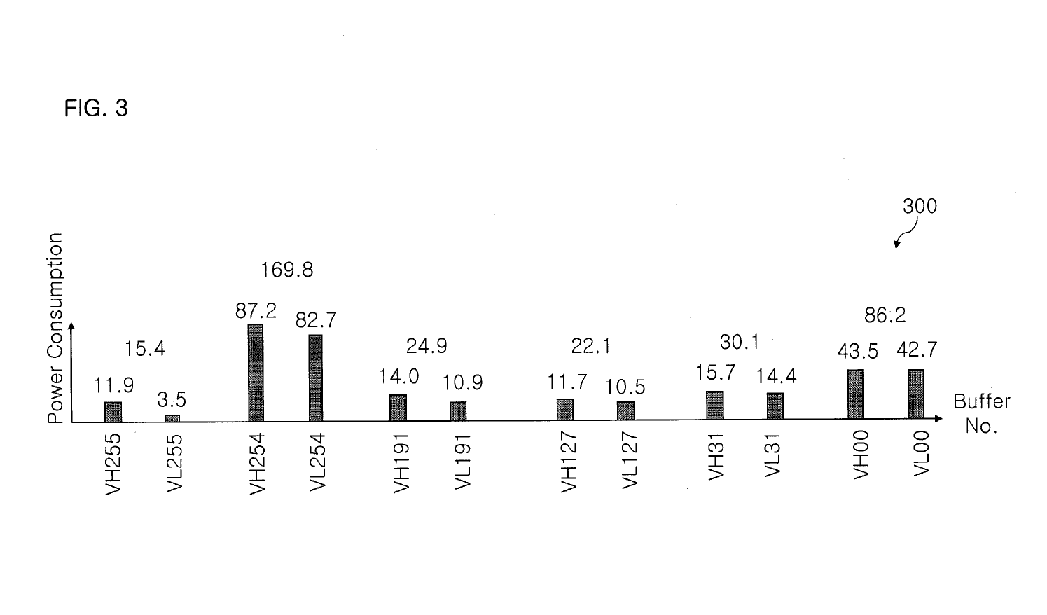

FIG. 4 is a view for explaining operations of calculating the power consumptions of the gamma buffers illustrated in FIG. 1;

FIG. 5 illustrates a flat panel display according to an embodiment of the present invention;

FIG. 6 illustrates temperatures of SDICs included in the flat panel display illustrated in FIG. 5 according to the present invention;

FIG. 7 illustrates power consumptions of gamma buffers included in the source drivers of the flat panel display illustrated in FIG. 5 according to the present invention;

FIG. 8 is a view for explaining operations of calculating the power consumptions of the gamma buffers illustrated in FIG. 5;

FIG. 9 illustrates a case where gamma reference voltages output from gamma buffers are applied to a resistor string after gamma buffer tab points of a second SDIC is changed;

FIG. 10 illustrates an environment in a case where a second gamma buffer is not applied to the resistor string;

FIG. 11 is a view illustrating temperatures of the SDICs including the gamma buffers measured on the basis of the connection structure between the gamma reference voltages and the resistor string illustrated in FIGS. 9 and 10;

FIG. 12 illustrates a flat panel display according to another embodiment of the present invention;

FIG. 13 illustrates temperatures of SDICs included in the flat panel display according to the present invention illustrated in FIG. 12;

FIG. 14 illustrates power consumptions of gamma buffers included in the flat panel display according to the present invention illustrated in FIG. 12;

FIG. 15 is a view for explaining operations of calculating the power consumptions of the gamma buffers illustrated in FIG. 12;

FIG. 16 illustrates a flat panel display according to another embodiment of the present invention;

FIG. 17 illustrates temperatures of SDICs included in the flat panel display according to the present invention illustrated in FIG. 16;

FIG. 18 illustrates power consumptions of the gamma buffers included in the SDICs of the flat panel display according to the present invention illustrated in FIG. 16;

FIG. 19 is a graph for comparing the power consumptions of the SDICs by the power consumptions of the gamma buffers;

FIG. 20 is a graph for comparing the temperatures of the SDICs by the power consumptions of the gamma buffers; and

FIG. 21 is a graph for comparing the temperatures of the SDICs in the conventional case, in the case where the gamma tab points are changed, and in the case where the positions of the gamma buffers are changed.

### DETAILED DESCRIPTION OF THE INVENTION

Hereinafter, exemplary embodiments of the present invention will be described in detail with reference to the attached drawings.

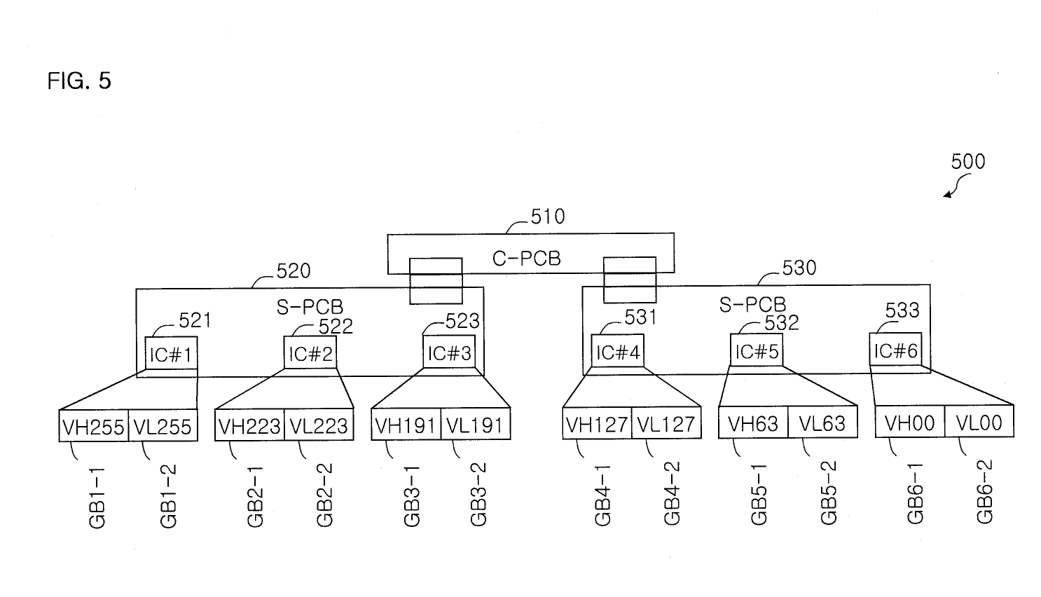

FIG. 5 illustrates a flat panel display according to an embodiment of the present invention.

Referring to FIG. 5, the flat panel display 500 includes a center printed circuit board (C-PCB) 510 and two source PCBs (S-PCBs) 520 and 530.

The C-PCB 510 controls operations of the two S-PCBs 520 and 530.

The first S-PCB 520 includes three source driver integrated circuits (SDICs) 521, 522, and 523.

The first SDIC 521 includes first and second buffers GB1-1 and GB1-2 for buffering voltages VH255 and VL255, respectively. The second SDIC 522 includes third and fourth buffers GB2-1 and GB2-2 for buffering voltages VH223 and VL223, respectively. The third SDIC 523 includes fifth and sixth buffers GB3-1 and GB3-2 for buffering voltages VH191 and VL191, respectively.

The second S-PCB 530 includes three SDICs 531,532, and 533.

The fourth SDIC 531 includes seventh and eight buffers GB4-1 and GB4-2 for buffering voltages VH127 and VL127, respectively. The fifth SDIC 532 includes ninth and tenth buffers GB5-1 and GB5-2 for buffering voltages VH63 and VL63, respectively. The sixth SDIC 533 includes eleventh and twelfth buffers GB6-1 and GB6-2 for buffering voltages VH00 and VL00, respectively.

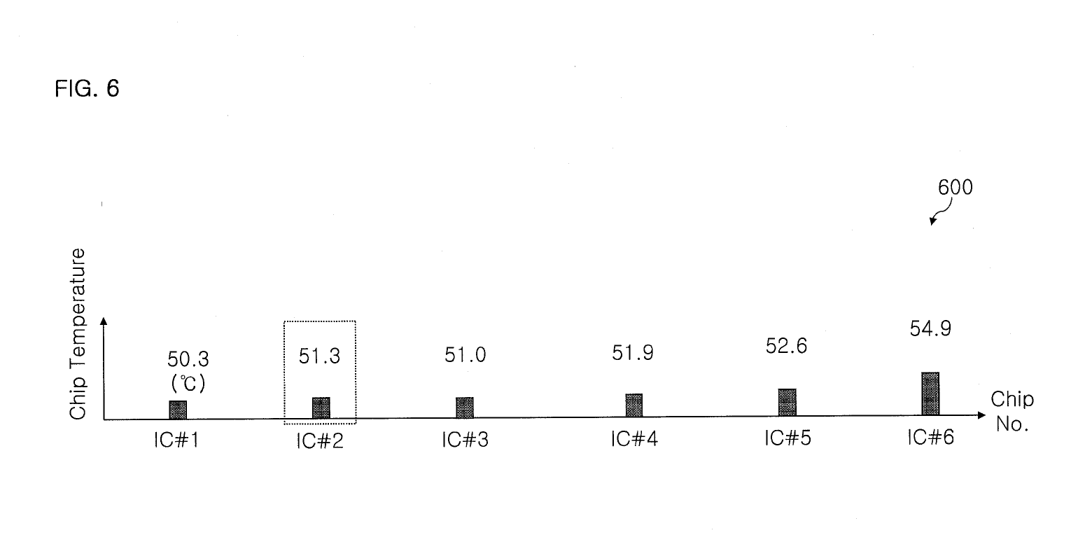

FIG. 6 illustrates temperatures of the SDICs included in the flat panel display according to the present invention illustrated in FIG. 5.

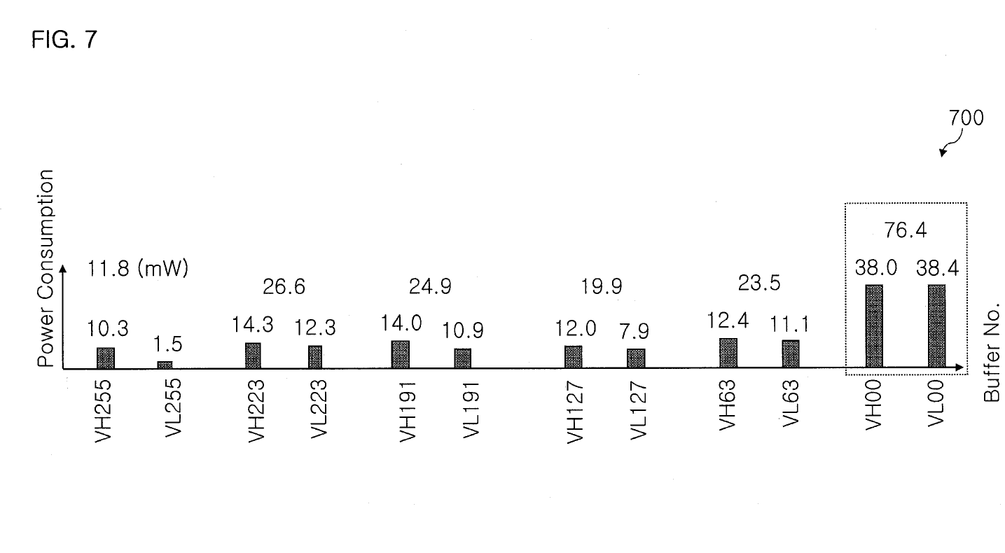

FIG. 7 illustrates power consumptions of the gamma buffers included in the source drivers of the flat panel display according to the present invention illustrated in FIG. 5.

Referring to FIGS. 6 and 7, the first SDIC IC#1 521 consumes 11.8 mW. Specifically, when the voltages VH255 and VL255 are buffered, powers of 10.3 mW and 1.5 mW are consumed by the corresponding gamma buffers of the first SDIC

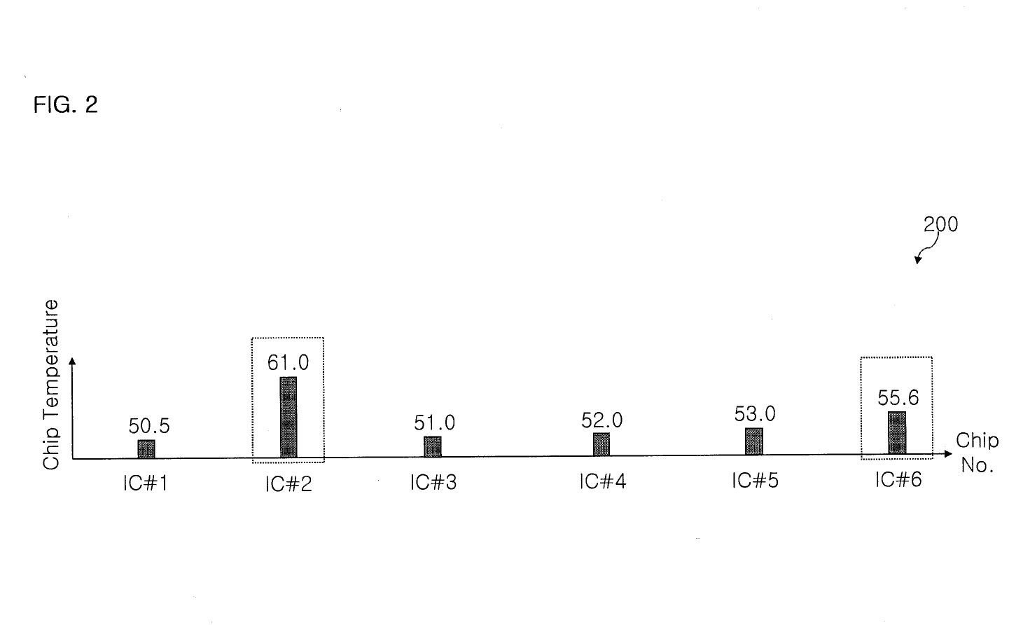

IC#1 521, respectively. In this case, a temperature of the first SDIC IC#1 521 is 50.3° C. The temperature is substantially the same as the temperature of 50.5° C. of the conventional SDIC 121 illustrated in FIG. 2.

The second SDIC IC#2 522 consumes 26.6 mW. Specifically, when the voltages VH223 and VL223 are buffered, powers of 14.3 mW and 12.3 mW are consumed by the corresponding gamma buffers of the second SDIC IC#2 522, respectively. In this case, a temperature of the second SDIC IC#2 522 is 51.3° C. The temperature is significantly decreased as compared with the temperature of 61.9° Cof the conventional SDIC 122 and is in the substantially the same level as the temperature of the first SDIC IC#1 521. This is because the second SDIC 522 buffers the gamma voltages corresponding to the VH223 and VL223 unlike the second SDIC 122 that buffers the gamma voltages corresponding to the VH254 and VL254.

The gamma voltages are transmitted to a resistor string described later. Referring to Equation 1, according to a resistance of the resistor string that operates as a load of each of the gamma voltages, powers consumed by the gamma buffers are changed. Therefore, in consideration of the gamma voltages buffered by the gamma buffers and the resistance of the resistor string that functions as a load of a corresponding gamma buffer, a gamma voltage that enables a power consumed by a gamma buffer to be minimized is calculated, and by applying this operation to the circuit, a method of decreasing a Kelvin of a SDIC including a corresponding gamma buffer is proposed.

Referring to FIGS. 2 and 6, the first SDIC IC#1 521 and the third SDIC IC#3 523 to the fifth SDIC IC#5 532 have substantially the same temperature characteristics as the first SDIC IC#1 121 and the third SDIC IC#3 123 to the fifth SDIC IC#5 132, respectively.

The sixth SDIC IC#6 533 consumes 76.4 mW. Specifically, when the voltages VH00 and VL00 are buffered, powers of 38.0 mW and 38.4 mW are consumed by the corresponding gamma buffers of the sixth SDIC IC#6 533, respectively. In this case, a temperature of the sixth SDIC IC#6 533 is 54.9° C. The temperature of the sixth SDIC IC#6 is lower than the temperature 55.6° C. of the conventional sixth SDIC IC#6 133 illustrated in FIG. 2 by 0.7° C.

As described with reference to FIGS. 5 to 7, by changing the gamma voltages buffered by the gamma buffers, that is, tab points of the gamma buffers from VH254 and VL254 to VH223 and VL223, respectively, the Kelvin of the SDIC including the gamma buffers can be minimized.

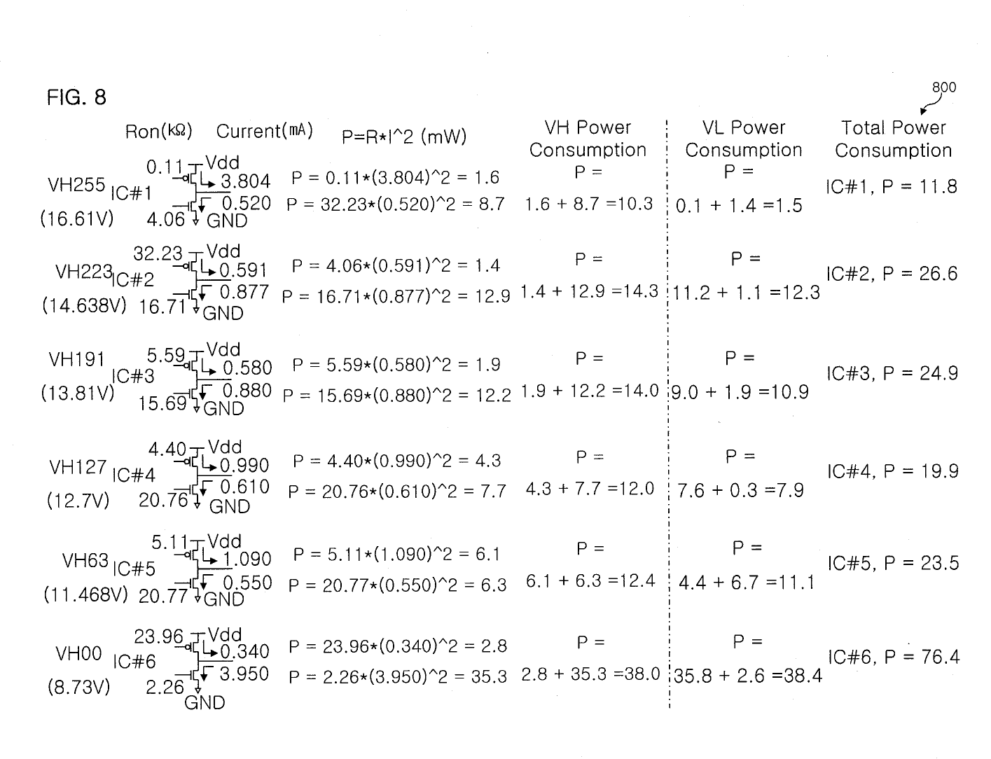

FIG. 8 is a view for explaining operations of calculating the power consumptions of the gamma buffers illustrated in FIG. 5.

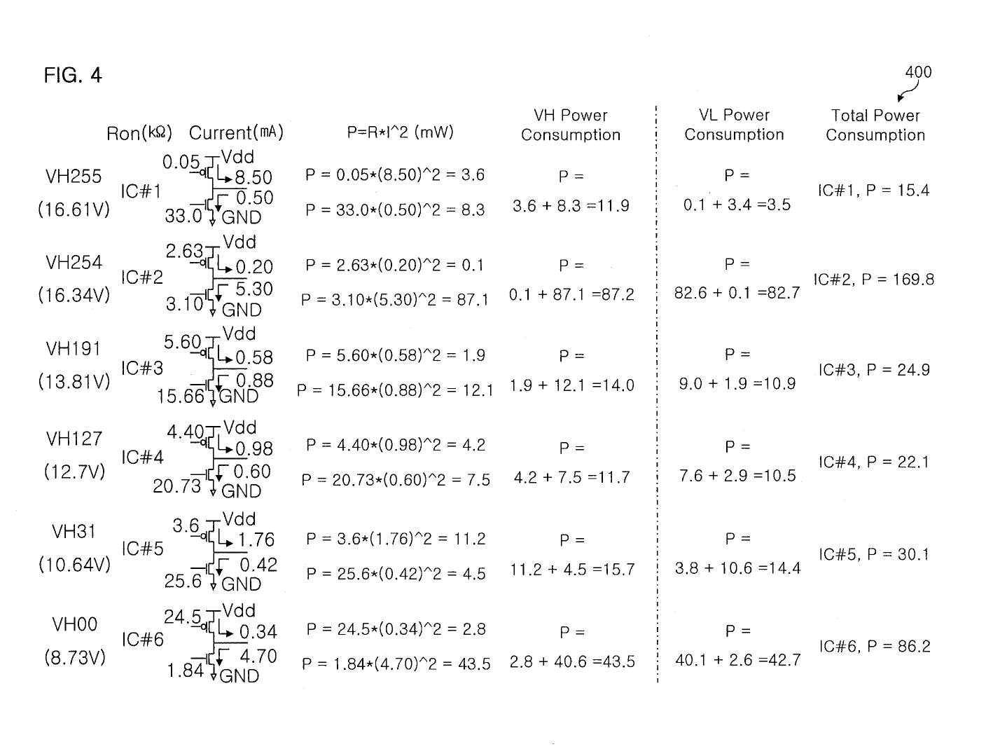

The operations of calculating the power consumptions of the gamma buffers illustrated in FIG. 4 are the same as the operations of calculating the power consumptions of the gamma buffers illustrated in FIG. 8.

In a case where the first gamma buffer GB1-1 of the first SDIC IC#1 buffers a voltage VH255 of 16.61 V, a turn-on resistance of a P-type MOS transistor is 0.11KΩ, a current flowing from a first source voltage Vdd to a load is 3.804 mA, a turn-on resistance of the N-type MOS transistor is 32.230KΩ, and a current flowing from the load to a second source voltage GND is 0.52 mA.

Using the Equation 1, a power consumed by the first gamma buffer GB1-1 of the first SDIC IC#1 is calculated as 10.3 mW. The power is a value obtained by adding a power of 1.6 mW consumed by the P-type MOS transistor and a power of 8.7 mW consumed by the N-type MOS transistor. In addition, a power consumed by the second gamma buffer GB1-2 of the first SDIC IC#1 is 1.5 mW (=0.1 mW+1.4 mW). Therefore, the total power consumed by the two gamma buffers GB1-1 and GB1-2 included in the first SDIC IC#1 is 11.8 mW.

Through the aforementioned calculations, the total power consumed by the first and second gamma buffers GB2-1 and GB2-2 of the second SDIC IC#2 is 26.6 mW (=14.3 mW+12.3 mW). Referring to FIG. 8, powers consumed by the gamma buffers included in the third to sixth SDICs IC#3 to IC#6 are 24.9 mW, 19.9 mW, 23.5 mW, and 76.4 mW, respectively.

The total power consumed by the first and second gamma buffers GB2-1 and GB2-2 of the second SDIC IC#2 of the conventional flat panel display illustrated in FIG. 4 is 169.8 mW (=87.2 mW+82.7 mW). However, the total power consumed by the first and second gamma buffers GB2-1 and GB2-2 of the second SDIC IC#2 of the flat panel display according to the present invention illustrated in FIG. 8 is 26.6 mV. It can be seen that the total power consumption is significantly reduced. In addition, the power consumed by the first and second gamma buffers GB6-1 and GB6-2 of the sixth SDIC IC#6 is 76.4 mW according to the present invention. Similarly, it can be seen that the power is reduced as compared with the conventional power consumption of 86.2 mW.

Improved effects of the flat panel display for changing the tab points of the gamma buffers of the second SDIC IC#2 according to the present invention are measured in a condition as follows.

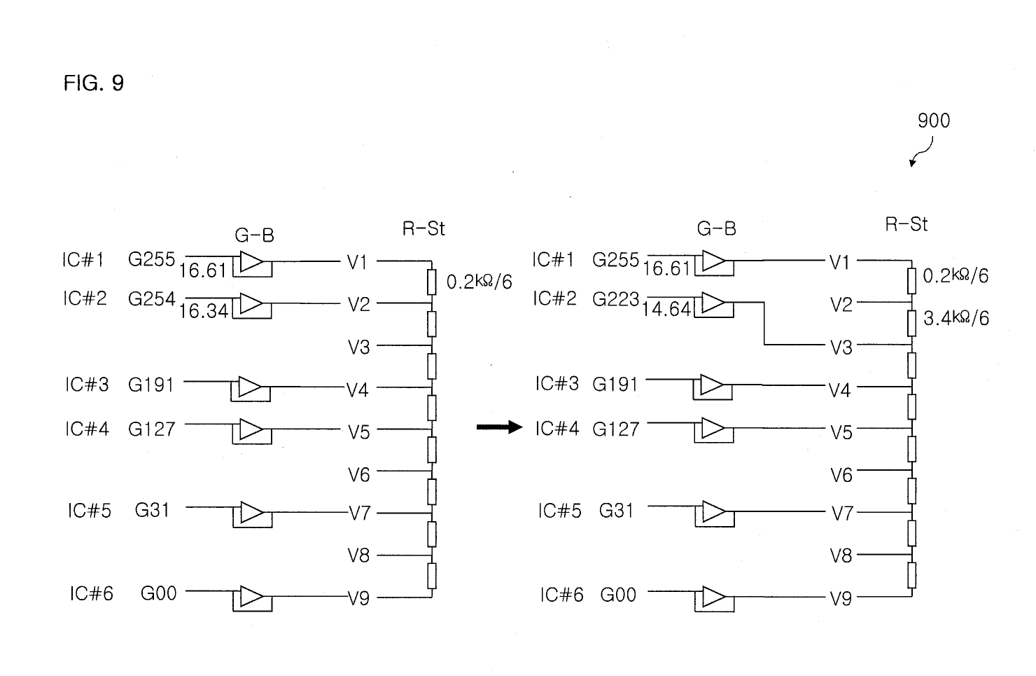

FIG. 9 illustrates a case where gamma reference voltages output from gamma buffers are applied to the resistor string after the gamma buffer tab points of the second SDIC IC#2 are changed.

Referring to FIG. 9, the resistor string includes 254 resistors connected in series and the total resistance is 14KΩ. In FIG. 9, total 8 resistors are illustrated. However, it means that each resistor includes a plurality of resistors connected in series.

Between the 8 resistors connected in series, six gamma reference voltages G255, G254, G191, G127, G31, and G00 are connected. FIG. 9 illustrates a conventional connection structure on the left and a connection structure according to the present invention on the right.

Referring to the connection structure of the conventional flat panel display illustrated on the left, the first gamma reference voltage G255 is buffered and connected to a node V1 and the second gamma reference voltage G254 is buffered and connected to a node V2. The third to sixth reference voltages G191 and G00 are connected to nodes V4, V5, V7, and V9, respectively.

Referring to the connection structure of the flat panel display for changing the tab points of the gamma buffers according to the present invention illustrated on the right, the second gamma reference voltage G223 is different from the second gamma reference voltage G254 illustrated on the left. In other words, the gamma buffer tab point is changed.

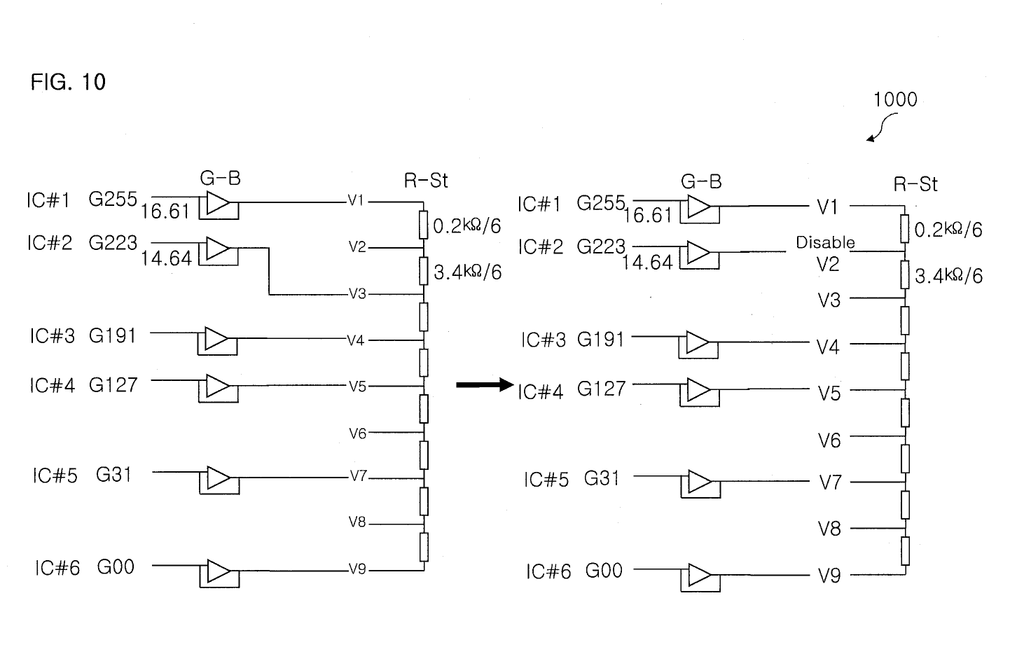

FIG. 10 illustrates an environment in a case where the second gamma buffer is not applied to the resistor string.

Referring to FIG. 10, the second gamma reference voltage G223 output from the second gamma buffer is not connected to the resistor string. Here, the power consumption of the gamma buffer has a constant value.

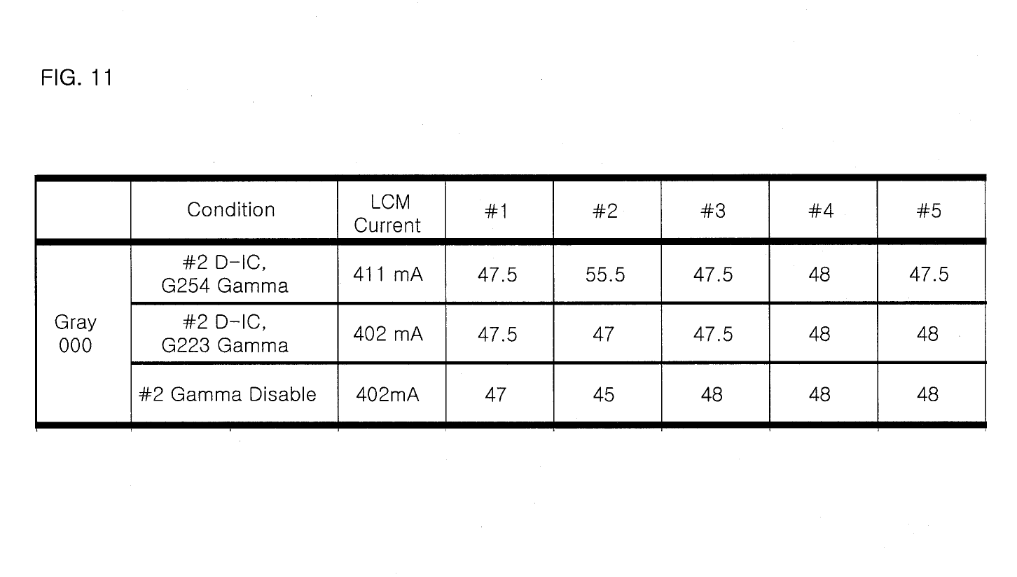

FIG. 11 is a view illustrating temperatures of the SDICs including the gamma buffers measured on the basis of the connection structure between the gamma reference voltages and the resistor string illustrated in FIGS. 9 and 10.

Referring to FIG. 11, a temperature of the second SDIC IC#2 in the conventional connection structure (referred to as #2 D-IC, G254 Gamma) is 55.5° C. However, a temperature of the second SDIC IC#2 in the connection structure (referred to as #2 D-IC, G223 Gamma) according to the present invention is 47° C. In addition, a temperature of the second SDIC IC#2 in the case where the second gamma buffer is not used is 45° C. In the aforementioned two cases, the temperature of the second SDIC IC#2 is lower than that in the conventional connection structure.

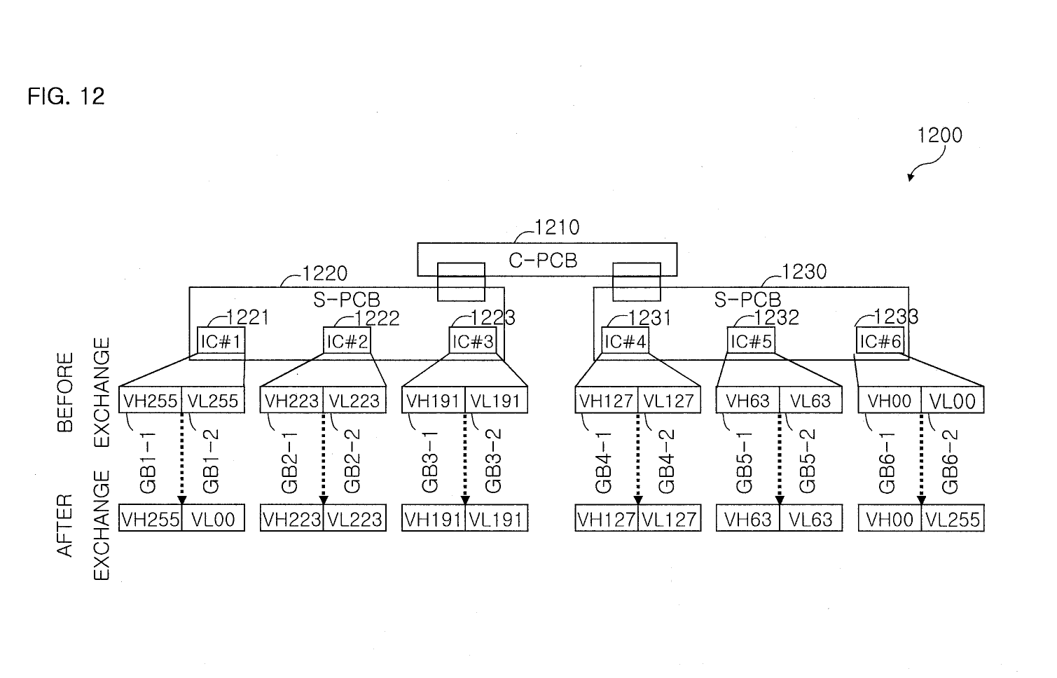

FIG. 12 illustrates a flat panel display according to another embodiment of the present invention.

Referring to FIG. 12, as compared with the structure of the flat panel display 500 illustrated in FIG. 5, in the flat panel display 1200 according to the present invention, a position of the second gamma buffer GB1-2 of the first SDIC 1221 is exchanged with a position of the second gamma buffer GB6-2 of the sixth SDIC 1233.

Specifically, the second gamma buffer GB1-2 of the first SDIC 1221 buffers a voltage corresponding to VL00, and the second gamma buffer GB6-2 of the sixth SDIC 1233 buffers a voltage corresponding to VL255. Specifically, the power consumption of the first gamma buffer GB1-1 of the first SDIC 1221 is lowest, and the second gamma buffer GB6-2 of the sixth SDIC 1233 is highest. Therefore, in order to uniform a temperature distribution of the chip according to a distribution of the power consumptions, a gamma buffer having a highest power consumption and a gamma buffer having a lowest power consumption are integrated into the same SDIC.

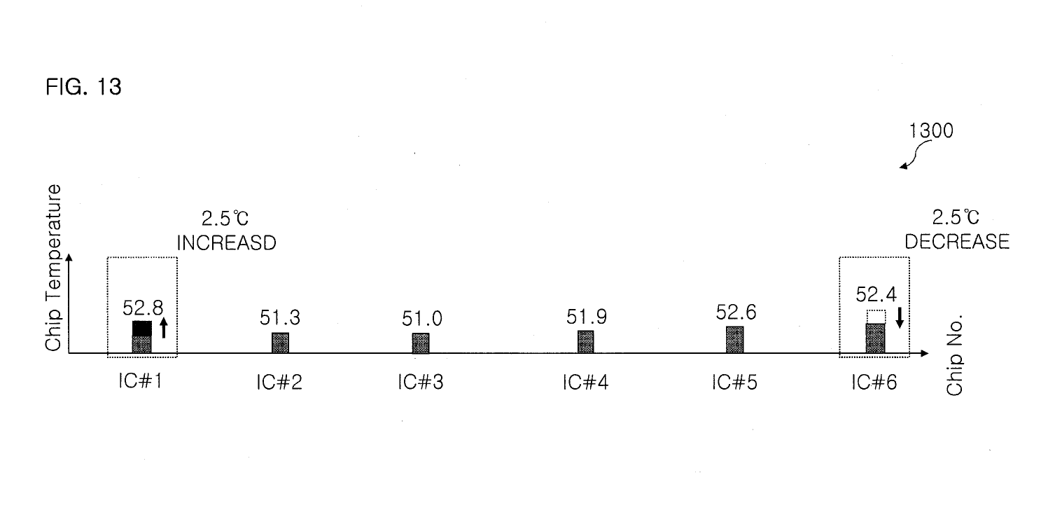

FIG. 13 illustrates temperatures of the SDICs included in the flat panel display according to the present invention illustrated in FIG. 12.

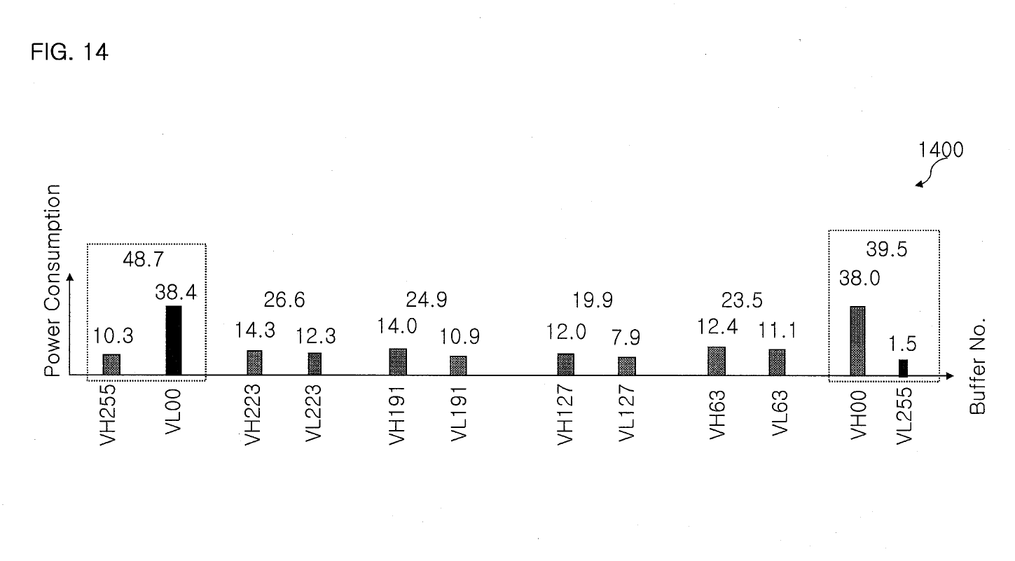

FIG. 14 illustrates power consumptions of gamma buffers included in the flat panel display according to the present invention illustrated in FIG. 12.

Referring to FIGS. 13 and 14, as illustrated in FIG. 12, the gamma buffer GB1-1 having the lowest power consumption and the gamma buffer GB1-2 having the highest power consumption are integrated into the same source driver, that is, the first SDIC 1221. Therefore, it can be seen that temperature deviations between the SDICs are uniform.

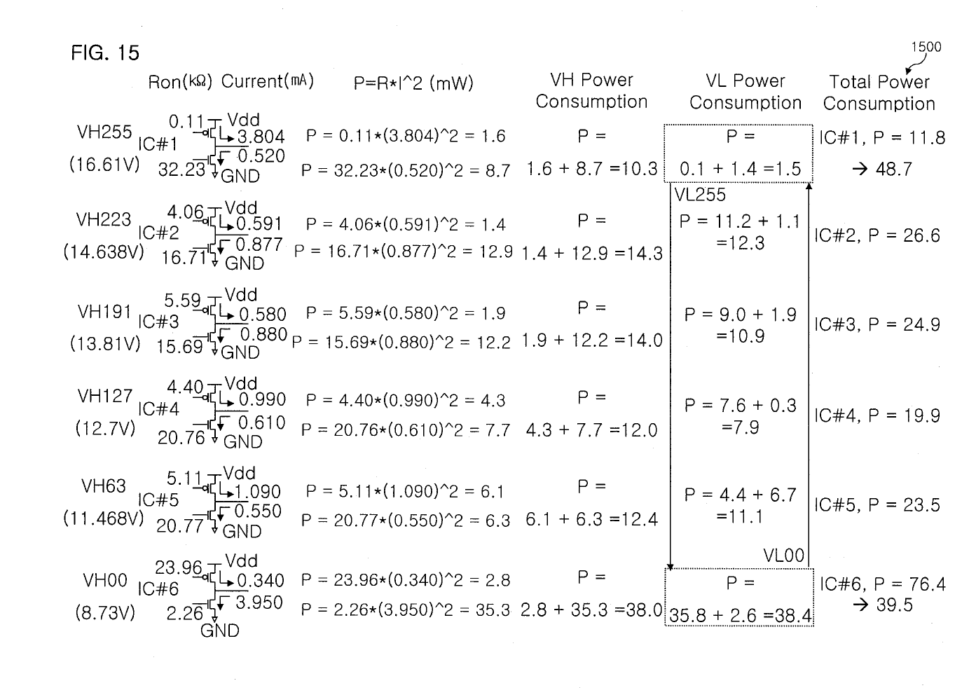

FIG. 15 is a view for explaining operations of calculating the power consumptions of the gamma buffers illustrated in FIG. 12.

Since the operations of calculating the power consumptions of the gamma buffers illustrated in FIG. 15 are the same as the operations of calculating illustrated in FIGS. 4 and 8, only features of the present invention are now described.

Referring to equations represented by a shade in FIG. 15 on the right, input voltages input to gamma buffers are exchanged so that the power consumptions of the corresponding gamma buffers are exchanged with each other. Therefore, the power consumed by the two gamma buffers included in the first SDIC IC#1 is increased from 11.8 mW to 48.7 mW after the exchange, and the power consumed by the two gamma buffers included in the sixth SDIC IC#6 is decreased from 76.4 mW to 39.5 mW.

The decrease or increase in the power consumption of the gamma buffers decreases or increases a temperature change in the SDICs. Referring to FIG. 13, the temperature of the first SDIC IC#1 is increased by 2.5° C. On the contrary, the temperature of the sixth SDIC IC#6 is decreased by 2.5° C. Therefore, the total power consumption is not changed. However, the temperature deviations between the SDICs are significantly reduced.

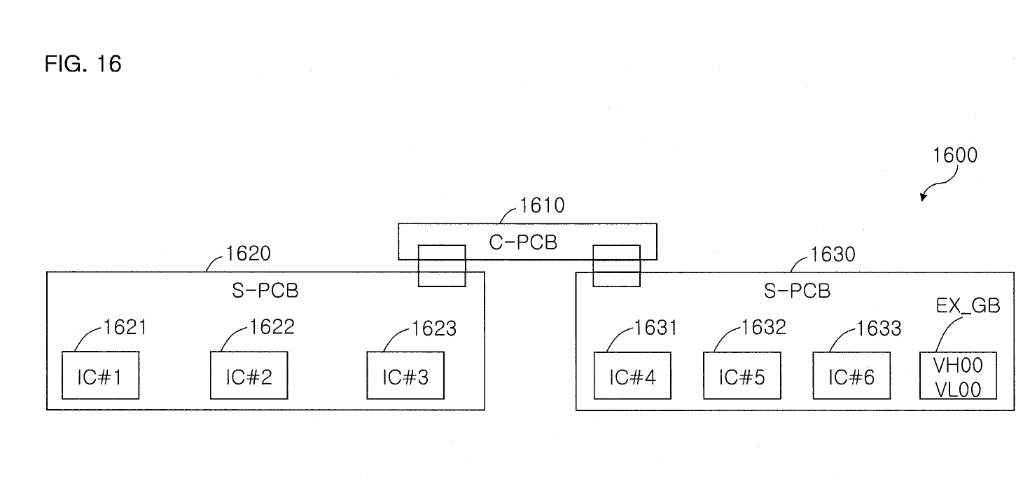

FIG. 16 illustrates a flat panel display according to another embodiment of the present invention.

Referring to FIG. 16, in the flat panel display 1600, the two gamma buffers Ex_GB included in the sixth SDIC 1233 of the flat panel display 1200 illustrated in FIG. 12 are provided outside the sixth SDIC 1233. Here, the two gamma buffers Ex_GB may be included in the same PCB as the sixth SDIC 1633.

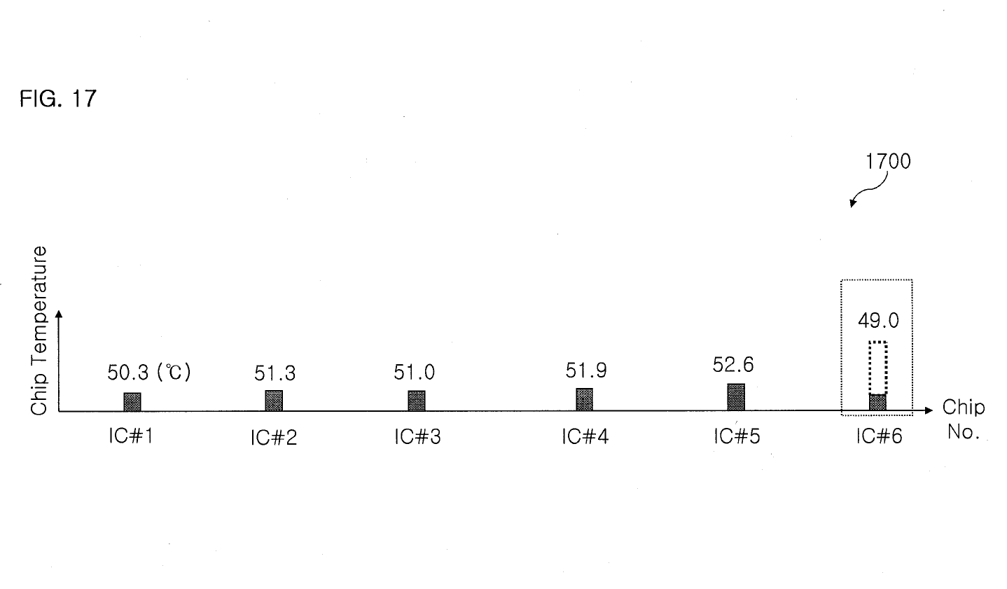

FIG. 17 illustrates temperatures of the SDICs included in the flat panel display according to the present invention illustrated in FIG. 16.

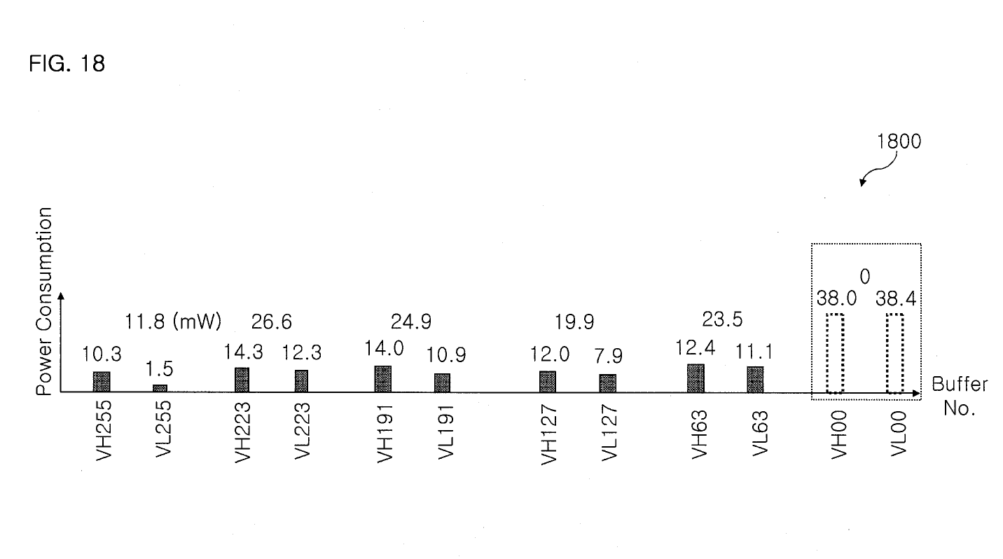

FIG. 18 illustrates power consumptions of the gamma buffers included in the SDICs of the flat panel display according to the present invention illustrated in FIG. 16.

Referring to FIGS. 17 and 18, the total power consumption of the sixth SDIC 1133 is decreased by the power consumed by the gamma buffers, and accordingly, the temperature is decreased.

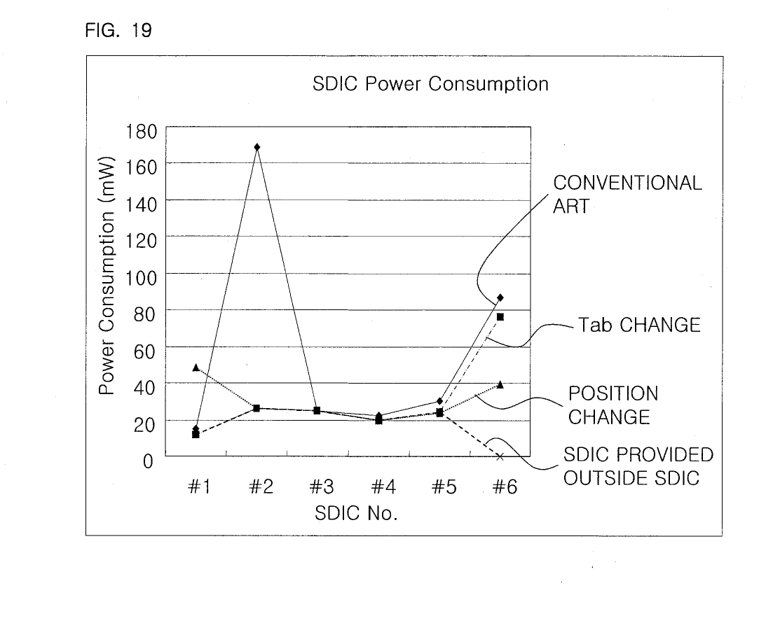

FIG. 19 is a graph for comparing the power consumptions of the SDICs by the power consumptions of the gamma buffers.

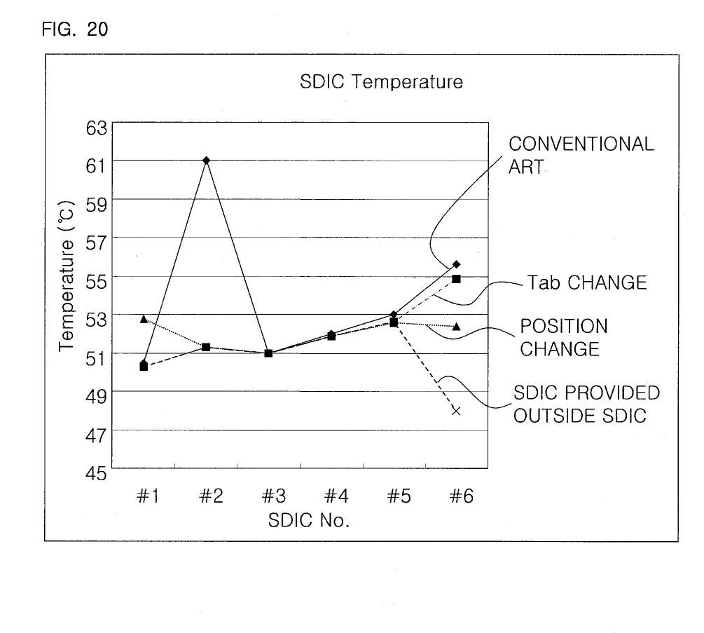

FIG. 20 is a graph for comparing the temperatures of the SDICs by the power consumptions of the gamma buffers.

Referring to FIGS. 19 and 20, by calculating the power consumptions of the gamma buffers, the temperatures of the SDICs including the gamma buffers can be predicted. In addition, on the basis of this, positions of the gamma buffers can be changed to minimize the temperature deviations between the SDICs.

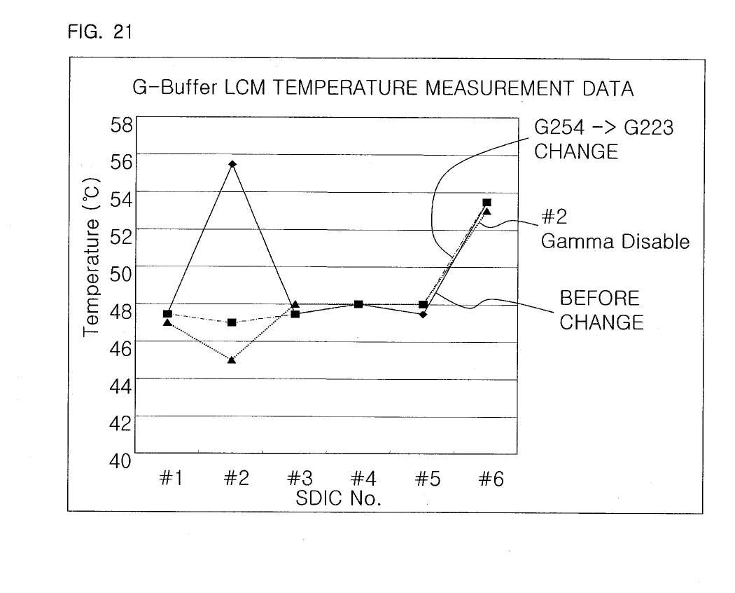

FIG. 21 is a graph for comparing the temperatures of the SDICs in the conventional case, in the case where the gamma tab points are changed, and in the case where the positions of the gamma buffers are changed.

Referring to FIG. 21, it can be seen that in the case where the gamma tab points are changed, the temperature of the second SDIC IC#2 is decreased by 8.5° C., and in the case where the positions of the gamma buffers are changed, the Kelvin of the SDIC can be reduced. In addition, in the case where the gamma buffers are not included in the source driver but moved on the PCB, the temperature is further decreased by 2° C. as compared with the case where the positions of the gamma tab points are changed.

Although FIGS. 5, 12, and 16 illustrate the flat panel displays, it can be seen that a method of arranging the gamma buffers are explained in FIGS. 5, 12, and 16 with reference to the detailed description for explaining the drawings. Therefore, it should be noted although the method of arranging the gamma buffers is not directly mentioned in the description, the method of arranging the gamma buffers is explained in the description.

As described above, the method of arranging the gamma buffers and the flat panel display according to the present invention has advantages of decreasing the Kelvin of the source driver included in the flat panel display, minimizing the temperature deviations between the source drivers, and improving a life span and reliability of the flat panel display.

While the present invention has been particularly shown and described with reference to exemplary embodiments thereof, it will be understood by those skilled in the art that various changes in form and details may be made therein without departing from the spirit and scope of the present invention as defined by the appended claims.

What is claimed is:

1. A method of arranging a plurality of gamma buffers which are arranged in one or more source drivers to output corresponding gamma voltages, comprising a step of calculating power consumptions of the gamma buffers,
wherein the method further comprises one or more steps of:
changing tab points of the gamma buffers by using the calculated power consumptions of the gamma buffers; and
changing positions of the gamma buffers by using the calculated power consumptions of the gamma buffers.

2. The method of claim 1, wherein in the step of changing the tab points of the gamma buffers, a voltage input to a gamma buffer consuming the highest power is exchanged with a voltage input to a corresponding gamma buffer consuming the lowest power.

3. The method of claim 1, wherein in the step of changing positions of the gamma buffers, a gamma buffer consuming the highest power and a gamma buffer consuming the lowest power are disposed at the same source driver integrated circuit.

4. The method of claim 3, wherein the step of changing the positions of the gamma buffers further comprises a step of providing the gamma buffer consuming the highest power outside of the corresponding source driver integrated circuit.

5. The method of claim 4, wherein the gamma buffer provided outside the source driver integrated circuit is provided to the same printed circuit board as the corresponding source driver integrated circuit.

6. A flat panel display comprising two or more gamma buffers and a plurality of source driver integrated circuits buffering a plurality of gamma voltages,
wherein, by calculating power consumptions of the gamma buffers included in a plurality of the source driver integrated circuits, among the gamma buffers, a position of a gamma buffer consuming the highest power and a position of a gamma buffer consuming the lowest power are exchanged with each other to be included in the same source driver integrated circuit.

7. The flat panel display of claim 6, wherein one or more gamma buffers consuming the highest power among a plurality of the gamma buffers are provided outside the corresponding source driver integrated circuit.

8. The flat panel display of claim 7, wherein the gamma buffers provided outside the corresponding source driver integrated circuit is included in the same printed circuit board as the corresponding source driver.
